(19) United States
(12) Patent Application Publication
(10) Pub. No.: US 2024/0047799 A1
(43) Pub. Date: Feb. 8, 2024

(54) BATTERY MODULE APPARATUS

(71) Applicant: Rivian IP Holdings, LLC, Plymouth, MI (US)

(72) Inventors: Tyler Jacobs, Redondo Beach, CA (US); Katelyn Rossick, Irvine, CA (US); Aaron Churchill, Irvine, CA (US)

(21) Appl. No.: 17/818,214

(22) Filed: Aug. 8, 2022

(51) Int. Cl. H01M 50/202; H01M 50/229; H01M 50/242; H01M 50/244; H01M 50/258; H01M 50/249

(52) U.S. Cl. CPC H01M 50/202; H01M 50/229; H01M 50/242; H01M 50/244; H01M 50/258; H01M 50/249; H01M 2220/20

(57) ABSTRACT

An apparatus can include a carrier having a pocket. The pocket can receive a battery cell to couple the carrier with the battery cell at a middle portion of the battery cell. The middle portion of the battery cell can cross a lateral midpoint of the battery cell.

### INTRODUCTION

Electric vehicles can include batteries that provide power to the electric vehicle. The batteries can be electrically coupled with vehicle components to power the vehicle.

### SUMMARY

Electrical systems, such as a battery module, may include one or more battery cells. The systems and methods of the present technical solution include an apparatus of a battery module. The apparatus can include a carrier having a plurality of pockets to carry battery cells of the battery module. The pockets of the carrier can be shaped and sized to receive each battery cell at an approximate middle portion of the respective battery cell. The carrier can include one or more embedded materials, such as glass-filled fiber, to strengthen the carrier. The carrier can include one or more ribs disposed at one or more portions of the carrier to provide support for the carrier. The carrier can improve efficiency of manufacturing by reducing part count and assembly sequence.

At least one aspect is directed to an apparatus. The apparatus can include a carrier having a pocket. The pocket can receive a battery cell to couple the carrier with the battery cell at a middle portion of the battery cell. The middle portion of the battery cell can cross a lateral midpoint of the battery cell.

At least one aspect is directed to a battery. The battery can include a battery cell. The battery can include a carrier having a pocket that can receive the battery cell. The pocket can couple the carrier with the battery cell at a middle portion of the battery cell. The middle portion of the battery cell can include a lateral midpoint of the battery cell.

At least one aspect is directed to a method. The method can include providing a carrier having a pocket. The method can include receiving, by the pocket, a battery cell to couple the carrier with the battery cell at a middle portion of the battery cell. The middle portion of the battery cell can cross a lateral midpoint of the battery cell.

At least one aspect is directed to a system. The system can include a battery module having a battery cell. The system can include a carrier having a pocket that can receive the battery cell. The pocket can couple the carrier with the battery cell at a middle portion of the battery cell. The middle portion of the battery cell can cross a lateral midpoint of the battery cell.

At least one aspect is directed to an electric vehicle. The electric vehicle can include a battery module having a battery cell. The electric vehicle can include a carrier having a pocket that can receive the battery cell. The pocket can couple the carrier with the battery cell at a middle portion of the battery cell. The middle portion of the battery cell can cross a lateral midpoint of the battery cell.

At least one aspect is directed to a method. The method can include providing an apparatus. The apparatus can include a carrier having a pocket. The pocket can receive a battery cell to couple the carrier with the battery cell at a middle portion of the battery cell. The middle portion of the battery cell can cross a lateral midpoint of the battery cell.

At least one aspect is directed to an apparatus. The apparatus can include a carrier having a pocket. The pocket can receive a battery cell to couple the carrier with the battery cell at a middle portion of the battery cell. At least a portion of the pocket can surround the middle portion of the battery cell.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example side view of an electric vehicle, in accordance with implementations.

FIG. 2A depicts an example perspective view of a battery pack, in accordance with implementations.

FIG. 2B depicts an example perspective view of a battery module, in accordance with implementations.

FIG. 2C depicts a cross sectional view of a battery cell, in accordance with implementations.

FIG. 3 depicts an example perspective view of an apparatus, in accordance with implementations.

FIG. 4 depicts an example perspective view of the apparatus of FIG. 3 receiving battery cells, in accordance with implementations.

FIG. 5 depicts an example perspective view of the apparatus of FIG. 3 with battery cells coupled with the apparatus, in accordance with implementations.

FIG. 6 depicts an example cross sectional view of battery cells coupled with a portion of the apparatus of FIG. 3, in accordance with implementations.

FIG. 7 depicts an example perspective view of a battery module, in accordance with implementations.

FIG. 8 depicts an example cross sectional view of the battery module of FIG. 7, in accordance with implementations.

FIG. 9 depicts an example perspective view of a portion of the apparatus of FIG. 3, in accordance with implementations.

FIG. 10 depicts an example perspective view of the apparatus of FIG. 3, in accordance with implementations.

FIG. 11 depicts an example illustration of a method, in accordance with implementations.

FIG. 12 depicts an example illustration of a method, in accordance with implementations.

### DETAILED DESCRIPTION

Following below are more detailed descriptions of various concepts related to, and implementations of, methods, apparatuses, and systems of coupling a battery with a vehicle. The various concepts introduced above and discussed in greater detail below may be implemented in any of numerous ways.

This disclosure is generally directed to battery module apparatus including a carrier tote for battery cells. The carrier tote can include one or more pockets (e.g., through holes) that can receive and contain a battery cell within the pocket. The pockets can be distributed about a base of the carrier tote to form a battery cell array. Each pocket can include a depth that is approximately (e.g., within 10%) half of a height of a battery cell that it receives such that the pocket facilitates mounting each battery cell with the carrier tote at an approximate center of gravity of each battery cell. The carrier tote can include one or more materials or features to facilitate strengthening the carrier tote. The carrier tote can include one or more glass-filled fiber materials. For example, the carrier tote can include 5-25% glass-filled fiber. The carrier tote can include one or more ribs disposed at one or more edge portions of the carrier tote. For example, the carrier tote can include a substantially rectangular shape and can include one or more ribs positioned at one or more corners of the rectangular carrier tote.

The disclosed solutions have a technical advantage of increasing structural integrity, lifetime, and battery cell structure. For example, the positioning of the battery cells within the pockets (e.g., at an approximate midpoint of the battery cells) and coupling the battery cells with the pocket by an adhesive can dampen vibrations of the battery cells within the pockets and can maintain the structural integrity of the battery cell housing. The positioning can also facilitate maintaining the battery cells at a distance from one another such that a thermal event of one battery cell may not cause a thermal event (e.g., heating of the battery cell, gas production, or another event) of one or more other battery cells within the battery cell carrier. The glass-filled fiber materials or the ribs of the carrier tote can facilitate increasing the structural integrity of the carrier tote such that bending or deformation of the carrier tote is reduced.

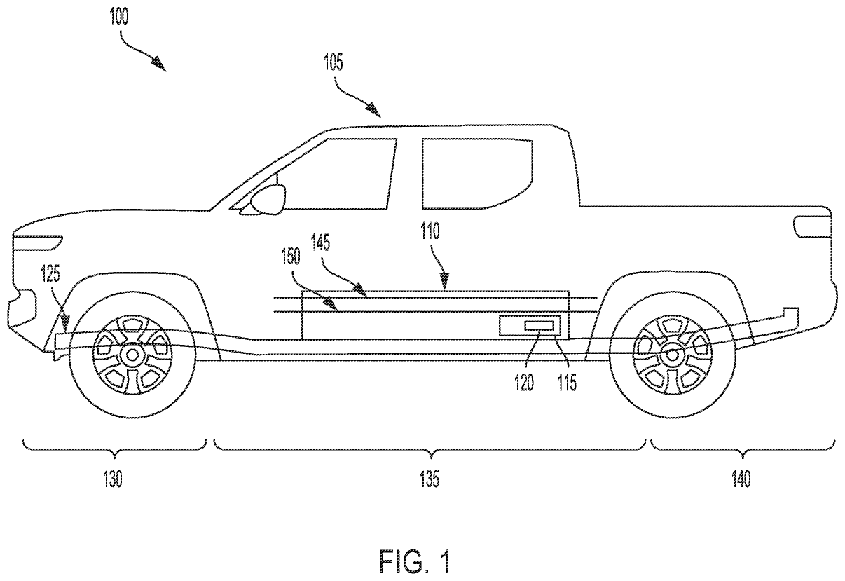

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

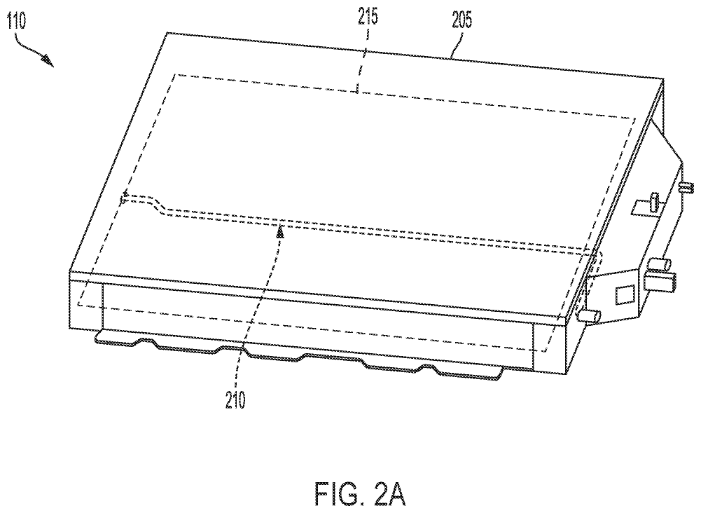

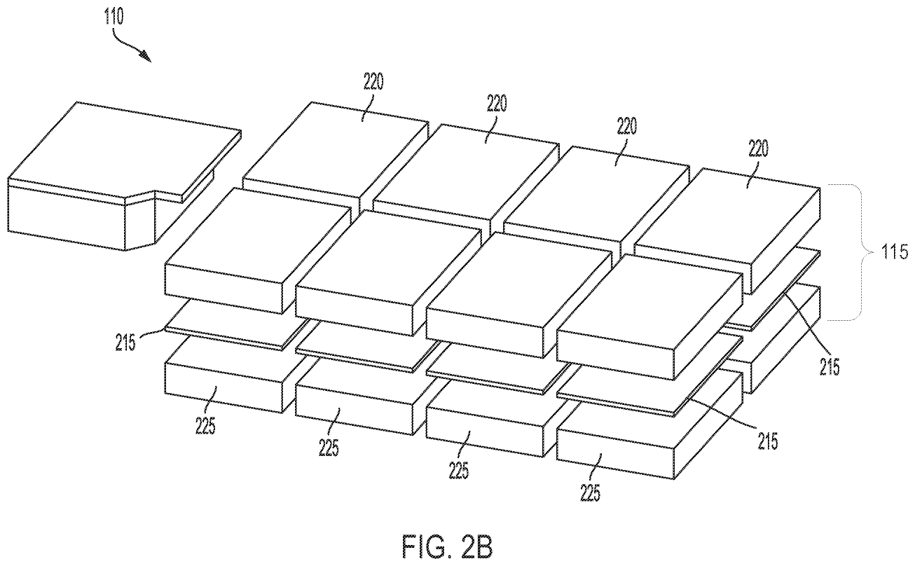

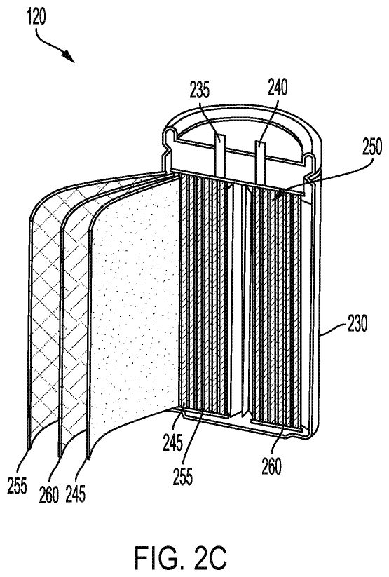

FIG. 2A depicts an example battery pack 110. Referring to FIG. 2A, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The battery module 115 can be or can include one or more groups of prismatic cells, cylindrical cells, pouch cells, or other form factors of battery cells 120. The housing 205 can include a shield on the bottom or underneath the battery module 115 to protect the battery module 115 or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, as described herein. The battery pack 110 can include any number of thermal components 215. For example, there can be one or more thermal components 215 per battery pack 110, or per battery module 115. At least one cooling line 210 can be coupled with, part of, or independent from the thermal component 215.

FIG. 2B depicts example battery modules 115, and FIG. 2C depicts an example cross sectional view of a battery cell 120. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells, pouch cells, prismatic cells, or another type of cell for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115 or cells 120. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

Battery cells 120 have a variety of form factors, shapes, or sizes. For example, battery cells 120 can have a cylindrical, rectangular, square, cubic, flat, pouch, elongated or prismatic form factor. Battery cells 120 can be assembled, for example, by inserting a winded or stacked electrode roll (e.g., a jelly roll) including electrolyte material into at least one battery cell housing 230. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 120 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 120. The housing 230 can be of various shapes, including cylindrical or rectangular, for example. Electrical connections can be made between the electrolyte material and components of the battery cell 120. For example, electrical connections to the electrodes with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include a lithium-ion battery cells. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Solid electrodes or electrolytes can be or include organic polymeric-based electrolytes or inorganic electrolytes, for example phosphide-based or Sulfide-based solid-state electrolytes (e.g., Li₃PS₄, Li₇P₃S₁₁, Li₂S—P₂S₅, Li₆PS₅Cl). Yet further, some battery cells 120 can be solid state battery cells and other battery cells 120 can include liquid electrolytes for lithium-ion battery cells.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted), elliptical, or ovular base, among others. The shape of the housing 230 can also be prismatic with a polygonal base, such as a triangle, a square, a rectangle, a pentagon, and a hexagon, among others. The battery pack 110 may not include modules 115. For example, the battery pack 110 can have a cell-to-pack configuration where battery cells 120 are arranged directly into a battery pack 110 without assembly into a module 115.

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 230 of the battery cell 120 is prismatic or cylindrical, the housing 230 can include a rigid or semi-rigid material such that the housing 230 is rigid or semi-rigid (e.g., not easily deformed or manipulated into another shape or form factor). In examples where the housing 230 includes a pouch form factor the housing 230 can include a flexible, malleable, or non-rigid material such that the housing 230 can be bent, deformed, manipulated into another form factor or shape.

The battery cell 120 can include at least one anode layer 245, which can be disposed within the cavity 250 defined by the housing 230. The anode layer 245 can include a first redox potential. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp2 hybridization), Li metal anode, or a silicon-based carbon composite anode. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 120 can include at least one cathode layer 255 (e.g., a composite cathode layer compound cathode layer, a compound cathode, a composite cathode, or a cathode). The cathode layer 255 can include a second redox potential that can be different than the first redox potential of the anode layer 245. The cathode layer 255 can be disposed within the cavity 250. The cathode layer 255 can output electrical current out from the battery cell 120 and can receive electrons during the discharging of the battery cell 120. The cathode layer 255 can also release lithium ions during the discharging of the battery cell 120. Conversely, the cathode layer 255 can receive electrical current into the battery cell 120 and can output electrons during the charging of the battery cell 120. The cathode layer 255 can receive lithium ions during the charging of the battery cell 120.

The battery cell 120 can include an electrolyte layer 260 disposed within the cavity 250. The electrolyte layer 260 can be arranged between the anode layer 245 and the cathode layer 255 to separate the anode layer 245 and the cathode layer 255. The electrolyte layer 260 can help transfer ions between the anode layer 245 and the cathode layer 255. The electrolyte layer 260 can transfer Li⁺ cations from the anode layer 245 to the cathode layer 255 during the discharge operation of the battery cell 120. The electrolyte layer 260 can transfer lithium ions from the cathode layer 255 to the anode layer 245 during the charge operation of the battery cell 120.

The redox potential of layers (e.g., the first redox potential of the anode layer 245 or the second redox potential of the cathode layer 255) can vary based on a chemistry of the respective layer or a chemistry of the battery cell 120. For example, lithium-ion batteries can include an LFP (lithium iron phosphate) chemistry, an NMC (Nickel Manganese Cobalt) chemistry, an NCA (Nickel Cobalt Aluminum) chemistry, or an LCO (lithium cobalt oxide) chemistry for a cathode layer (e.g., the cathode layer 255). Lithium-ion batteries can include a graphite chemistry, a silicon-graphite chemistry, or a lithium metal chemistry for the anode layer (e.g., the anode layer 245). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, other additives as a coating on a current collector (metal foil). The chemical composition of the electrode layers can affect the redox potential of the electrode layers. For example, cathode layers (e.g., the cathode layer 255) can include high-nickel content (>80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer 245) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 260 can include or be made of a liquid electrolyte material. For example, the electrolyte layer 260 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 260 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 260 can include or be made of a solid electrolyte material, such as a ceramic electrolyte material, polymer electrolyte material, or a glassy electrolyte material, or among others, or any combination thereof. The ceramic electrolyte material for the electrolyte layer 260 can include, for example, lithium phosphorous oxy-nitride (LiₓPO_{y}N_{z}), lithium germanium phosphate sulfur (Li₁₀GeP₂Si₂), Yttria-stabilized Zirconia (YSZ), NASICON (Na₃Zr₂Si₂PO₁₂), beta-alumina solid electrolyte (BASE), perovskite ceramics (e.g., strontium titanate (SrTiO₃)), among others. The polymer electrolyte material (e.g., a hybrid or pseudo-solid state electrolyte) for electrolyte layer 260 can include, for example, polyacrylonitrile (PAN), polyethylene oxide (PEO), polymethyl-methacrylate (PMMA), and polyvinylidene fluoride (PVDF), among others. Whether the electrolyte layer 260 is a separator layer that can receive a liquid electrolyte (e.g., lithium ion batteries) or an electrolyte layer that can conduct ions without receiving a liquid electrolyte (e.g., solid-state batteries), the glassy electrolyte material for the electrolyte layer 260 can include, for example, lithium sulfide-phosphor pentasulfide (Li₂S—P₂S₅), lithium sulfide-boron sulfide (Li₂S—B₂S₃), and Tin sulfide-phosphor pentasulfide (SnS—P₂S₅), among others.

In examples where the electrolyte layer 260 includes a liquid electrolyte material, the electrolyte layer 260 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 260 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 260 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 260 from greater than 0 M to about 1.5 M.

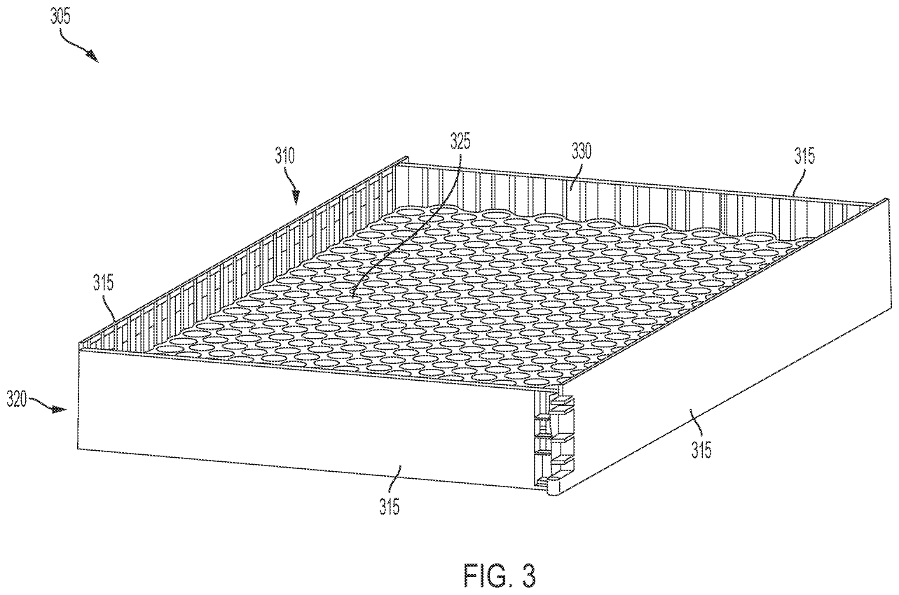

FIG. 3 depicts an example perspective view of an apparatus 305 of the vehicle 105. The apparatus 305 can be or can include a carrier tote 310 (referred to as the carrier 310). The carrier 310 can include or can be a base 320 having one or more walls 315 surrounding the base 320. The base 320 can include at least one pocket 325. For example, the pocket 325 can be or can include an opening, through hole, slot, or other component that can receive a battery cell 120. The base 320 can include a plurality of pockets 325 each distributed in an array pattern about the base 320. For example, the base 320 can include a plurality of pockets 325 arranged in a generally honeycombed pattern, or other type of pattern, such that each pocket receives a corresponding battery cell 120 in the corresponding pattern. Each pocket 325 can include a through hole having one or more surrounding surfaces that separate each pocket 325 from one another. For example, each pocket 325 can include a height that is approximately (±10%) half of a height of a corresponding side wall 315 of the base (e.g., at least one portion of the pocket, such as the through hole of the pocket 325, includes a height that is about half a height of the side walls 315). For example, at least a portion of a surrounding surface of the pocket 325 can be disposed at a height that reaches about half a height of the side walls 315 (e.g., at least a portion of the pocket 325 reaches half of a height of a side wall 315).

At least one side wall 315 of the base 320 of the carrier 310 can include one or more grooves 330 positioned along one or more inside surfaces of the side walls 315 to facilitate aligning each battery cell 120. The pockets 325 or the grooves 330 of the carrier 310 can include various shapes (e.g., cylindrical, round, oblong, hexagonal, prismatic, pouch, or another shape) to accommodate and receive each battery cell 120. The battery cells 120 can be coupled with the pockets 325 using one or more adhesives as described herein. For example, adhesives can facilitate mounting each battery cell 120 to each pocket 325 such that movement of the battery cells 120 relative to the pockets 325 is limited. As described herein, the battery cell 120 can include a cylindrical battery cell, a prismatic battery cell, a pouch battery cell, or another type of cell.

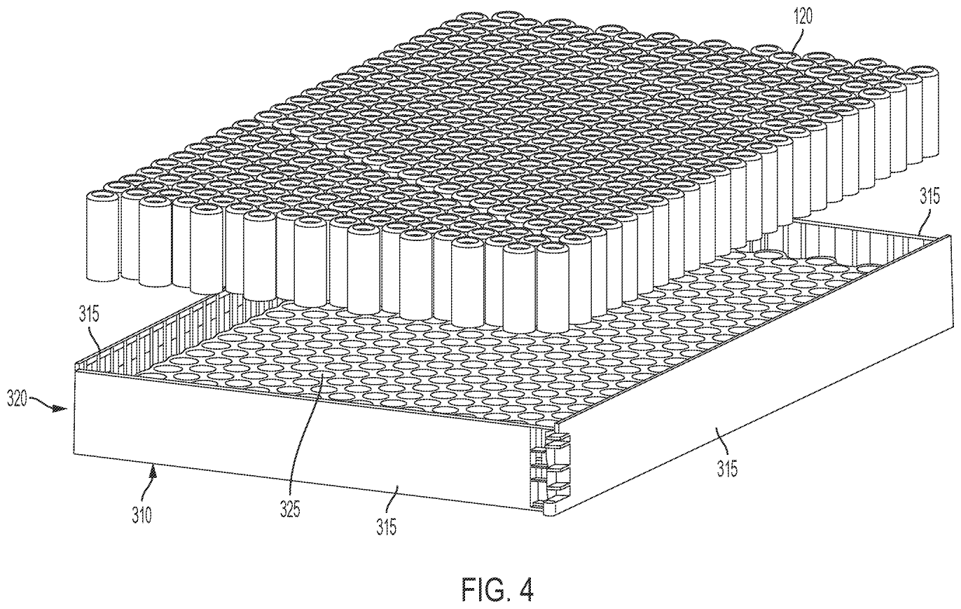

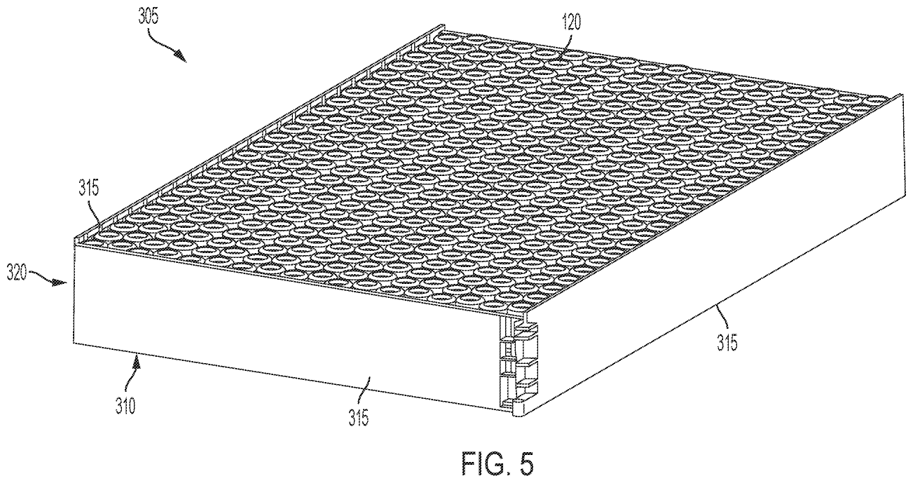

FIG. 4 depicts an example perspective view of the apparatus 305 and a plurality of battery cells 120. The battery cells 120 are depicted above the carrier 310 for illustrative purposes (e.g., to illustrate alignment of the battery cells 120 with respect to the pocket 325). FIG. 5 depicts a perspective view of the carrier 310 in which the plurality of pockets 325 of the carrier 310 each include a corresponding battery cell 120 received in the pocket 325. The carrier 310 can include a various amount of pockets 325 to accommodate a various amount of battery cells 120. For example, the carrier 310 can include at least one pocket 325. The carrier 310 can include more than one pocket 325. The pockets 325 can include one or more profiles that correspond with a profile of the battery cell 120. For example, the carrier 310 can include a pocket 325 having a generally cylindrical shape to receive a cylindrical battery cell 120. The pocket 325 can include a generally rectangular shape to receive a prismatic battery cell 120, as another example. The pocket 325 can include a generally pouch shape to receive a pouch battery cell 120, as yet another example.

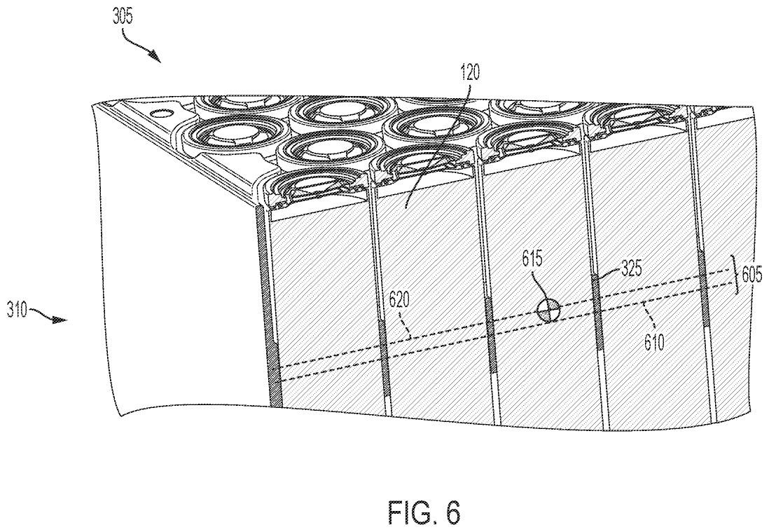

FIG. 6 depicts an example cross-sectional view of battery cells 120 received within respective pockets 325 of the carrier 310. The pocket 325 can receive the battery cell 120 such that the battery cell 120 couples with the carrier 310 at a middle portion 605 of the battery cell 120. For example, the middle portion 605 of the battery cell 120 can be or can include an approximate longitudinal center of the battery cell 120. At least a portion of the pocket 325 can surround (e.g., enclose, support, overlap, contact, abut) the middle portion 605 of the battery cell 120. For example, the pocket 325 can include at least one surface that overlaps a portion of the battery cell 120 at the middle portion 605 as depicted in at least FIG. 6. The middle portion 605 of the battery cell 120 can cross a lateral midpoint 610 of the battery cell 120. For example, the middle portion 605 can include ±10% of the longitudinal height of the battery cell 120 from the lateral midpoint 610 of the battery cell 120 such that a line extending laterally through the lateral midpoint 610 of the battery cell 120 crosses (e.g., is within) the middle portion 605 of the battery cell 120. In other words, the battery cell 120 can couple with the pocket 325 such that at least a portion of the pocket 325 surrounds the lateral midpoint 610 of the battery cell 120 in a lateral direction (e.g., in a direction perpendicular to an axial direction of the battery cells 120).

The middle portion 605 of the battery cell 120 can include a center of gravity 615 of the battery cell 120. For example, a lateral line 620 extending through the center of the gravity 615 of the battery cell 120 can be within the middle portion of the battery cell 120 such that at least a portion of the pocket 325 surrounds (e.g., circumferentially) the center of gravity 615 of the battery cell 120 when the battery cell 120 is coupled with the pocket 325.

The center of gravity 615 of the battery cell 120 can correspond to the lateral midpoint 610 of the battery cell 120. For example, the battery cell 120 can include a symmetrical housing 230 such that the center of gravity 615 of the battery cell 120 is located at the longitudinal or lateral center of the housing 230 of the battery cell 120. The center of gravity 615 of the battery cell 120 can be offset from the lateral midpoint 610 of the battery cell 120. For example, the battery cell 120 can include one or more components disposed at a first end of the housing 230 of the battery cell 120 (e.g., one or more terminals or other components) such that the battery cell 120 is not exactly symmetrical in mass. In other words, one or more components of the battery cell 120 can cause the center of gravity 615 to deviate from the lateral midpoint 610 of the battery cell 120. Even in this case, the middle portion 605 of the battery cell 120 can cross the center of gravity 615 of the battery cell 120 such that at least a portion of the pocket 325 surrounds the center of gravity 615 of the battery cell 120 (e.g., the lateral line 620 that extends through the center of gravity 615 is within the middle portion 605 such that the lateral line 620 extends through a surface of the pocket 325). The lines representing the lateral midpoint 610 and the lateral line 620 depicted in FIG. 6 are for illustrative purposes. For example, the lines can be or can include imaginary lines.

One or more adhesives can facilitate coupling a battery cell 120 with a respective pocket 325 (e.g., by forming an adhesive joint). For example, an adhesive can be disposed between in inner wall of the pocket 325 and an outer wall of the battery cell 120 (e.g., the housing 230 of the battery cell 120) to mount the battery cell 120 in the pocket 325. At least a portion of the adhesive joint can surround the center of gravity 615 of the battery cell 120. For example, the adhesive joint can at least partially surround the middle portion 605 of the battery cell 120 when the battery cell 120 is coupled with the pocket 325. For example, an inner wall of the pocket 325 can reach at least the lateral midpoint 610 of the battery cell 120 such that the adhesive is disposed at or below the lateral midpoint 610 of the battery cell 120 (e.g., in the pocket 325). In other words, the adhesive can facilitate mounting a portion of the battery cell housing 230 with an inner wall of the pocket 325 (e.g., with a portion of the base 320 of the carrier 310 that surrounds each pocket 325 and separates the pockets 325 from one another).

The adhesive can be a wicking adhesive (e.g., a thin adhesive capable of seeping into cracks or crevices) such that the adhesive can flow to the area between the housing 230 of the battery cell 120 and the inner wall (e.g., surrounding surface) of the pocket 325 (e.g., by a capillary effect). The adhesive can undergo one or more operations to facilitate forming a bond between the housing 230 of the battery cell 120 and the inner wall of the pocket 325. For example, the adhesive can be cured. The adhesive can be a quick-dry adhesive (e.g., dries in under 5 minutes or another type of adhesive). The adhesive can be a two-part adhesive (e.g., two parts of an adhesive are mixed to start a reaction to cure).

The adhesive can facilitate forming an adhesive joint at the middle portion 605 of the battery cell 120 such that relative movement between the battery cell 120 and the pocket 325 is limited when the battery cell 120 is coupled with the pocket 325. For example, at least a portion of the middle portion 605 of the battery cell 120 can be glued (e.g., by an adhesive) to the pocket 325 such that vibrations of the battery cell 120 during various operations (e.g., while the vehicle 105 is off, while the vehicle 105 is in park, while the vehicle 105 is being driven, or during another operation) of the vehicle 105 is dampened (e.g., dampen vibrations such that random vibrations are above a frequency of 150 hz). For example, having the pocket 325 reach the middle portion 605 of the battery cell 120 can accommodate for a first mode frequency target of the battery module 115 (e.g., by being higher than the input frequency of the random vibration profile.) The size of the pocket 325 (e.g., having a depth large enough to receive the middle portion 605 of the battery cell 120) and the adhesive joint formed between the pocket 325 and the battery cell 120 can dampen vibrations such that a lifetime of the battery cells 120 or the carrier 310 is extended (e.g., less stress or fatigue of the battery cells 120 or the carrier 310).

Coupling the battery cell 120 with the pocket 325 at the middle portion 605 of the battery cell 120 provides structural support for the battery cell 120 in relation to other battery cells 120 coupled to a respective pocket 325 of the carrier 310. For example, coupling the battery cells 120 at a middle portion 605 of the battery cells 120 can reduce relative movement between the battery cells 120 of the battery cell array of the carrier 310 (e.g., the plurality of battery cells 120 each coupled with a respective pocket 325) as compared to coupling the battery cells 120 with the pockets 325 along a portion of the battery cell 120 that is distant from the middle portion 605 (e.g., distant from the lateral midpoint 610 of the battery cell 120 or distant from the center of gravity 615 of the battery cell 120, more than 10% of the height of the housing 230 of the battery cell 120 away from the lateral midpoint 610 or center of gravity 615 of the battery cell 120). For example, the pocket 325 (e.g., the inner wall surface surrounding the through hole of the pocket 325 that receives a battery cell 120) can include a depth that is about equal to half of a height of the housing 230 of the battery cell 120 (±10%) such that about half of the housing 230 of the battery cell 120 is in contact, directly or indirectly (e.g., by the adhesive), with an inner wall of the pocket 325. Coupling the pocket 325 with the battery cell 120 at the middle portion 605 of the battery cell 120 allows for a larger surface area coverage between the pocket 325 and the housing 230 of the battery cell 120 (e.g., about half of the housing 230 of the battery cell 120 or more than half) as compared to coupling the pocket 325 with the battery cell 120 at a portion of the battery cell 120 that is distant from the middle portion 605 of the battery cell 120 (e.g., about one-fourth or one-third the height of the housing 230 of the battery cell 120 or less). The pocket 325, or another portion of the carrier 310, can include one or more thermal features (e.g., heat sinks or another component that can couple with the thermal component 215).

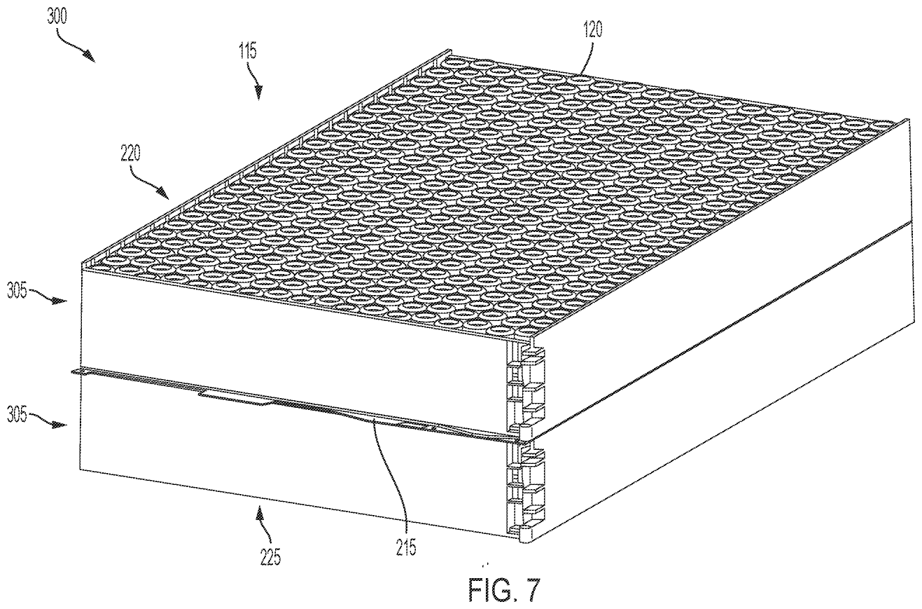

FIG. 7 depicts an example perspective view of a battery module system 300. The system 300 can include a battery module 115. For example, as described herein, the battery module 115 can include a first submodule 220 and a second submodule 225. The battery module 115 can include a thermal component 215 disposed between the first submodule 220 and a second submodule 225. The first submodule 220 and the second submodule 225 can each include or can each be a carrier 310. For example, the first submodule 220 can include a carrier 310 to carry a plurality of battery cells 120 of the first submodule 220 and the second submodule 225 can include a carrier 310 to carry a plurality of battery cells 120 of the second submodule 225.

The thermal component 215 can couple with each carrier 310 in a variety of ways. For example, the thermal component 215 can couple with one or more respective battery cells 120 (e.g., a surface of the housing 230 of a battery cell 120 can couple with a surface of the thermal component 215 by one or more thermal adhesives). For example, each battery cell 120 can couple with the thermal component 215 and with the carrier 310 by a pocket 325 such that the thermal component 215 is coupled with the carrier 310. The thermal component 215 can couple with the carrier 310 by a variety of other ways including, but not limited to, welding or fasteners. For example, the battery module 115 can include or can couple with one or more shear walls by one or more fasteners. The battery module 115 can couple with another portion of the vehicle 105, such as the battery pack 110, by one or more fasteners. For example, the carrier 310 can include one or more flanges to clamp the thermal component 215 between the first submodule 220 and the second submodule 225. As another example, the thermal component 215 can include one or more flanges. The one or more flanges can include various holes, divots, or other apertures that can receive a fastener to facilitate coupling the battery module 115 with another portion of the battery pack 110.

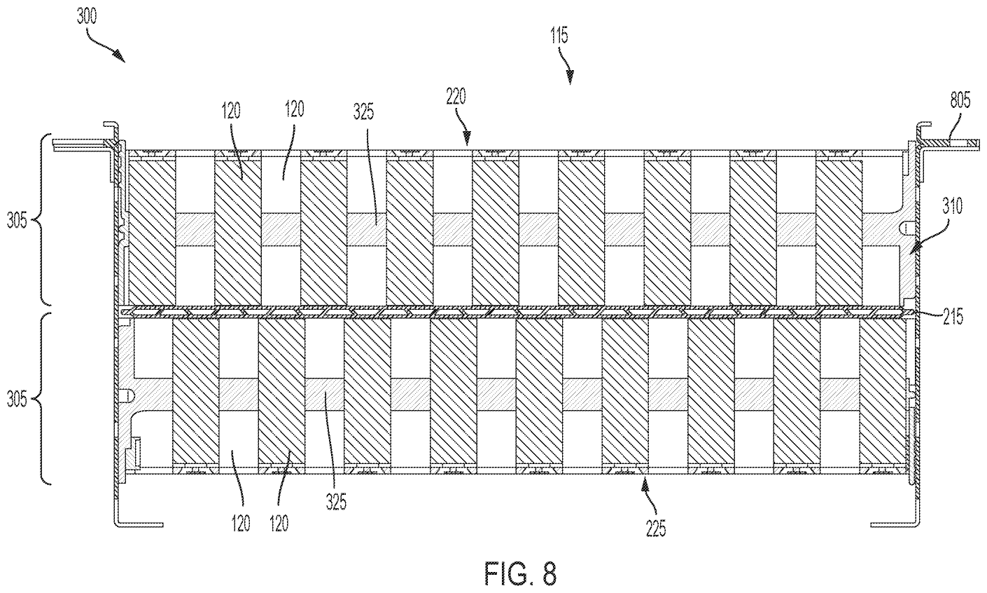

FIG. 8 depicts an example cross sectional view of a battery module 115. As described herein, the battery module 115 can include or can couple with one or more shear walls 805. The shear walls 805 can include at least one flange that protrudes beyond a side surface of the battery module 115 (e.g., beyond a side surface of the first submodule 220 or second submodule 225). The flange of the shear walls 805 can receive one or more fasteners to facilitate mounting the battery module 115 to the battery pack 110 (e.g., by coupling with one or more cross members of the battery pack 110). The battery module 115 may not include any shear walls 805. For example, the thermal component 215 can include one or more flanges that extend beyond the battery module 115. The one or more flanges can include an aperture to receive a fastener to facilitate coupling the thermal component 215 and the battery module 115 with the battery pack 110.

At least a portion of the pocket 325 can be disposed at a longitudinal or lateral center point of the corresponding battery submodule. For example, at least a portion of one pocket 325 of the first submodule 220 can be disposed at an approximate (±10%) center of the first submodule 220 such that at least a portion of the pocket 325 surrounds the battery cell 120 around a center of the battery cell 120 (e.g., such that the pocket 325 includes a depth that is about equal to half a height of the first submodule 220 in a direction extending from the second (e.g., bottom) submodule 225 towards the first (e.g., top) submodule 220). As another example, at least a portion of one pocket 325 of the second submodule 225 can be disposed at an approximate (±10%) center of the second submodule 225 such that at least a portion of the pocket 325 surrounds the battery cell 120 around a center of the battery cell 120 (e.g., such that the pocket 325 includes a depth that is about equal to half a height of the second submodule 225 in a direction extending from the second (e.g., bottom) submodule 225 towards the first (e.g., top) submodule 220).

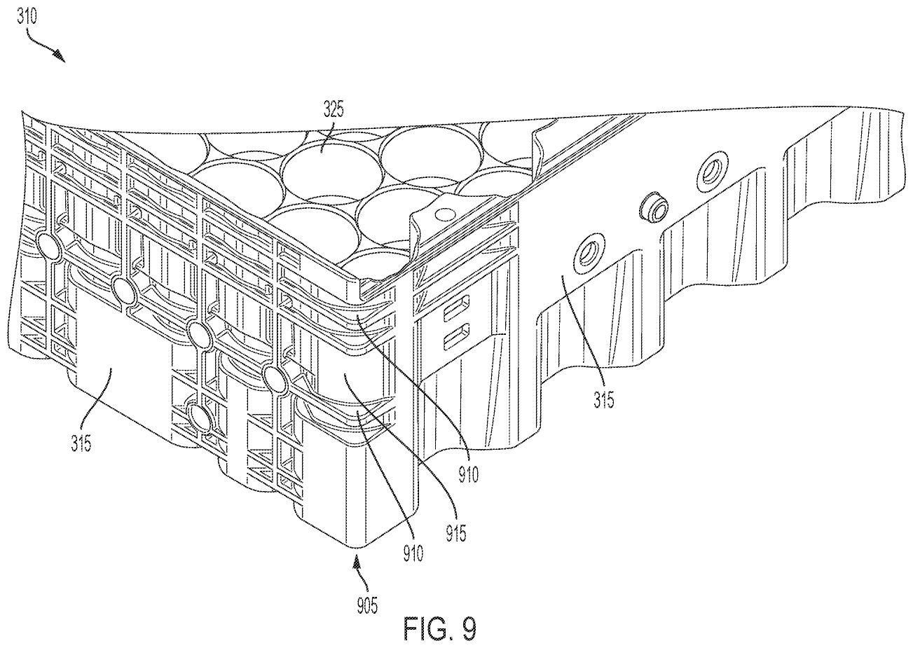

FIG. 9 depicts an example perspective view of a portion of a carrier 310. One or more side walls 315 of the carrier 310 can meet at an intersection 905 of the carrier 310. For example, the carrier 310 can include a generally rectangular shape such that the carrier 310 has four corners formed between four side walls 315. Each corner can be or can include an intersection 905 of the side walls 315. This example is for illustrative purposes only. The carrier 310 can include a variety of shapes including, but not limited to, triangular, pentagonal, asymmetrical, symmetrical, or another shape.

One or more intersections 905 between the side walls 315 can include at least one rib 910. For example, the intersections 905 can include a generally straight, flat, or curved surface 915 joining a first side wall 315 and a second side wall 315. The ribs 910 can protrude from the surface of the intersection 905 as depicted in at least FIG. 9, and among others. The ribs 910 can facilitate reducing bending or flexing of the carrier 310. For example, the ribs 910 can facilitate reducing bending of the carrier 310 at the intersection 905 in comparison to a curved or flat surface 915 that does not include any ribs 910. For example, the ribs 910 can increase the bending stiffness of the carrier 310 by 10-15%, or more. The ribs 910 can protrude various distances from the surface 915 of the carrier 310. For example, the ribs 910 can protrude about 1 mm from the surface 915. The ribs 910 can protrude about 5 mm from the surface 915, as another example. The ribs 910 can protrude about 10 mm from the surface 915, as another example. These examples are for illustrative purposes only. The ribs 910 can protrude significantly greater than or lesser than 1-10 mm. For example, the ribs 910 may not protrude from the surface 915 (e.g., protrudes 0 mm). As another example, the ribs 910 can protrude 1 m from the surface 915.

The carrier 310 can include any amount of ribs 910. For example, the carrier 310 can include one rib 910. The carrier 310 can include two ribs 910. The carrier 310 can include three or more ribs 910. The carrier 310 can include one or more ribs 910 at each intersection 905 (e.g., each corner) of the carrier 310, for example. The carrier 310 can include ribs 910 disposed at other portions of the carrier 310. For example, the carrier 310 can include one or more ribs 910 positioned along another portion of one or more side walls 315. The ribs 910 can each have a similar configuration (e.g., in shape or size) or the ribs 910 can differ in one or more ways. For example, the ribs 910 can vary in thickness (e.g., in an axial direction of the pockets 325) or in depth (e.g., protruding from the surface 915).

The carrier 310 can include one or more components to facilitate providing strength and structure for the carrier 310. For example, the carrier 310 can be formed from one or more plastic materials. The carrier 310 can be formed by one or more molding process (e.g., injection molding or another type of molding) using one or more plastic materials. The carrier 310 can include one or more materials to add additional stiffness, hardness, tensile strength, or another change of characteristic to the material of the carrier 310. For example, the carrier 310 can include glass-filled materials (e.g., glass-filled fibers, glass-filled polymers, glass-filled plastic, or another material). The glass-filled materials can be coupled with the plastic of the carrier 310. For example, the glass-filled materials can be formed with the plastic by one or more molding techniques (e.g., injection molding). The glass-filled materials can be coupled with the plastic in various other ways.

The carrier 310 can include various amounts of glass-filled materials. For example, the carrier 310 can include 0% glass-filled materials. The carrier 310 can include 5-25% glass-filled materials (e.g., 5%, 10%, 15%, 20%, or another percentage in the range of 5-25%), as another example. The carrier 310 can include more than 25% glass-filled materials. For example, the carrier 310 can include 60% glass-filled materials.

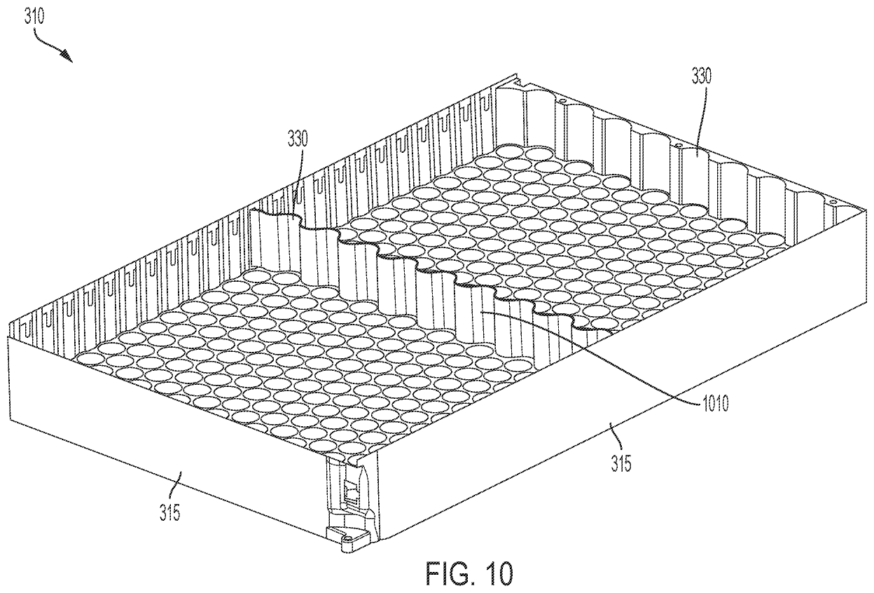

FIG. 10 depicts an example perspective view of a carrier 310. The carrier 310 can include one or more dividing walls 1010. For example, the carrier 310 can include a wall 1010 (e.g., a surface) disposed at an approximate center of the carrier 310 in a longitudinal or lateral direction of the carrier 310. The wall 1010 can include a profile similar to that of a side wall 315 of a carrier 310. For example, the wall 1010 can include one or more grooves 330 to facilitate guiding or receiving a battery cell 120. For example, the wall 1010 can form one or more inner surfaces of one or more pockets 325 of the carrier 310. The wall 1010 can extend laterally or longitudinally across an entirety of the carrier 310 (e.g., between two side walls 315) to provide structural support for the carrier 310. For example, the wall 1010 can facilitate dampening relative movement between two or more side walls 315 coupled with the wall 1010 by forming a joint (e.g., by welding, adhesives, molding, fasteners, or another technique) between ends of the wall 1010 and the side walls 315. The wall 1010 can be disposed at various positions of the carrier 310. For example, the wall 1010 can be disposed at a longitudinal center of the carrier 310. The wall 1010 can be disposed at a lateral center of the carrier 310. The wall 1010 can be disposed off-center in a lateral or longitudinal direction of the carrier 310, as another example.

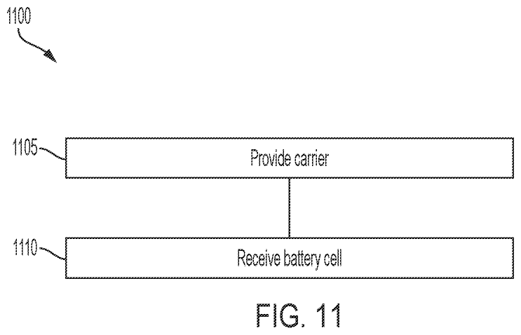

FIG. 11 depicts an example illustration of a method 1100. The method 1100 can include providing a carrier 310, as depicted in act 1105. For example, the carrier 310 can include at least one pocket 325. The pocket 325 can be or can include a through hole disposed in the carrier 310. The through hole can be surrounded by one or more surfaces (e.g., inner walls) to form the pocket 325 that surrounds the through hole. The pocket 325 can receive a battery cell 120. For example, the through hole of the pocket 325 can receive a battery cell 120 such that the surrounding inner walls of the pocket 325 abut, contact, or at least partially surround the battery cell 120 in a circumferential direction. The pocket 325 can include a shape that corresponds to a profile of the housing 230 of the battery cell 120. For example, the pocket 325 can include a cylindrical shape to receive a cylindrical battery cell 120. The pocket 325 can include a rectangular shape to receive a prismatic battery cell 120. These examples are for illustrative purposes only. The pocket 325 can include a variety of shapes or sizes to accommodate various battery cells 120.

The method 1100 can include receiving a battery cell 120 to couple the carrier 310 with the battery cell 120 at a middle portion 605 of the battery cell 120, as depicted in act 1110. The pocket 325 (e.g., a through hole extending from a surface that surrounds the battery cell 120 to an end of the carrier 310 that abuts the thermal component 215 of the battery module 115) can include a depth that is about equal to (±10%) half of a height of the battery cell 120. For example, an inner wall or surface of the pocket 325 that surrounds at least a portion of the through hole can surround a portion of the battery cell 120 that is about equal to half of a height of the housing 230 of the battery cell 120 in an axial direction of the battery cell 120. The pocket 325 (e.g., the through hole or a surrounding surface of the through hole) can include a depth that is greater than half of the height of the battery cell 120. With this configuration, the pocket 325 can receive the battery cell 120 such that the pocket 325 at least partially surrounds the middle portion 605 of the battery cell 120. For example, the middle portion 605 of the battery cell 120 can be or can include an approximate longitudinal center of the battery cell 120. The middle portion 605 of the battery cell 120 can cross a lateral midpoint 610 of the battery cell 120. For example, the middle portion 605 can include ±10% of the longitudinal height of the battery cell 120 from the lateral midpoint 610 of the battery cell 120 such that a line extending laterally through the lateral midpoint 610 of the battery cell 120 crosses (e.g., is within) the middle portion 605 of the battery cell 120. In other words, the battery cell 120 can couple with the pocket 325 such that at least a portion of the pocket 325 surrounds the lateral midpoint 610 of the battery cell 120 in a lateral direction (e.g., in a direction perpendicular to an axial direction of the battery cells 120).

The middle portion 605 of the battery cell 120 can include a center of gravity 615 of the battery cell 120. For example, a lateral line 620 extending through the center of the gravity 615 of the battery cell 120 can be within the middle portion of the battery cell 120 such that at least a portion of the pocket 325 surrounds (e.g., circumferentially) the center of gravity 615 of the battery cell 120 when the battery cell 120 is coupled with the pocket 325.

The center of gravity 615 of the battery cell 120 can correspond to the lateral midpoint 610 of the battery cell 120. For example, the battery cell 120 can include a symmetrical housing 230 such that the center of gravity 615 of the battery cell 120 is located at the longitudinal or lateral center of the housing 230 of the battery cell 120. The center of gravity 615 of the battery cell 120 can be offset from the lateral midpoint 610 of the battery cell 120. For example, the battery cell 120 can include one or more components disposed at a first end of the housing 230 of the battery cell 120 (e.g., one or more terminals or other components) such that the battery cell 120 is not exactly symmetrical in mass. In other words, one or more components of the battery cell 120 can cause the center of gravity 615 to deviate from the lateral midpoint 610 of the battery cell 120. Even in this case, the middle portion 605 of the battery cell 120 can cross the center of gravity 615 of the battery cell 120 such that at least a portion of the pocket 325 surrounds the center of gravity 615 of the battery cell 120 (e.g., the lateral line 620 that extends through the center of gravity 615 is within the middle portion 605 such that the lateral line 620 extends through a surface of the pocket 325).

The method 1100 can include receiving an adhesive in an area between the housing 230 of the battery cell 120 and the inner wall of the pocket 325 while the battery cell 120 is coupled with the pocket 325. For example, the method 1100 can include forming an adhesive joint between the pocket 325 and the battery cell 120 at the middle portion 605 of the battery cell 120. As described herein, the adhesive joint can at least partially surround the center of gravity 615 of the battery cell 120. For example, the adhesive can seep into the space between the housing 230 of the battery cell 120 and the pocket 325 such that the adhesive at least partially surrounds the battery cell 120 in a circumferential direction. The pocket 325 can include a height that is large enough to at least reach the middle portion 605 of the battery cell 120 such that the adhesive within the pocket 325 at least partially surrounds the middle portion 605 of the battery cell 120. The adhesive can facilitate dampening vibration of the battery cell 120 relative to the pocket 325 when the battery cell 120 is coupled with the pocket 325.

The carrier 310 can include various features or components that provide structure for the carrier 310. For example, the carrier 310 can include one or more ribs 910 disposed along a portion of the carrier 310, such as an intersection 905 between two or more side walls 315 of the carrier 310. The ribs 910 can protrude from a surface 915 of the intersection 905. The carrier 310 can include various materials. For example, the carrier 310 can be formed from one or more plastic materials. The carrier 310 can be formed by various techniques including, but not limited to, injection molding. The carrier 310 can include a variety of materials that facilitate providing rigidity and structure for the carrier 310. For example, the carrier 310 can include one or more glass-filled materials coupled (e.g., embedded, molded with, or coupled in another way) with the material of the carrier 310.

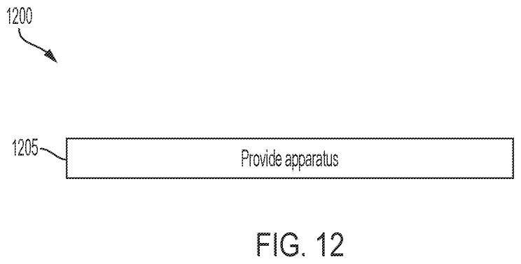

FIG. 12 depicts an example illustration of a method 1200. The method 1200 can include providing an apparatus 305, as depicted in act 1205. The apparatus 305 can be or can include the carrier 310. The carrier 310 can include or can be a base 320 having one or more walls 315 surrounding the base 320. The base 320 can include at least one pocket 325. For example, the pocket 325 can be or can include an opening, through hole, slot, or other component that can receive a battery cell 120. The pocket 325 can include one or more inner walls or surfaces that surround the through hole to surround the battery cell 120 when the pocket 325 receives the battery cell 120. The base 320 can include a plurality of pockets 325 each distributed in an array pattern about the base 320. For example, the base 320 can include a plurality of pockets 325 arranged in a generally honeycombed pattern such that each pocket 325 receives a corresponding battery cell 120. Each pocket 325 can include a height that is approximately (±10%) half of a height of a corresponding side wall 315 of the base 320 (e.g., at least one surrounding surface of the pocket 325 includes a height that is about half a height of the side walls 315).

At least one side wall 315 of the base 320 of the carrier 310 can include one or more grooves 330 positioned along one or more inside surfaces of the side walls 315 to facilitate aligning each battery cell 120. The pockets 325 or the grooves 330 of the carrier 310 can include various shapes (e.g., cylindrical, round, oblong, hexagonal, prismatic, pouch, or another shape) to accommodate and receive each battery cell 120. The battery cells 120 can be coupled with the pockets 325 using one or more adhesives as described herein. For example, adhesives can facilitate mounting each battery cell 120 to each pocket 325 such that movement of the battery cells 120 relative to the pockets 325 is limited.

The pocket 325 can receive the battery cell 120 such that the pocket 325 at least partially surrounds the middle portion 605 of the battery cell 120. For example, the middle portion 605 of the battery cell 120 can be or can include an approximate longitudinal center of the battery cell 120. The middle portion 605 of the battery cell 120 can cross a lateral midpoint 610 of the battery cell 120. For example, the middle portion 605 can include ±10% of the longitudinal height of the battery cell 120 from the lateral midpoint 610 of the battery cell 120 such that a line extending laterally through the lateral midpoint 610 of the battery cell 120 crosses (e.g., is within) the middle portion 605 of the battery cell 120. In other words, the battery cell 120 can couple with the pocket 325 such that at least a portion of the pocket 325 surrounds the lateral midpoint 610 of the battery cell 120 in a lateral direction (e.g., in a direction perpendicular to an axial direction of the battery cells 120).

The middle portion 605 of the battery cell 120 can include a center of gravity 615 of the battery cell 120. For example, a lateral line 620 extending through the center of the gravity 615 of the battery cell 120 can be within the middle portion of the battery cell 120 such that at least a portion of the pocket 325 surrounds (e.g., circumferentially) the center of gravity 615 of the battery cell 120 when the battery cell 120 is coupled with the pocket 325.

The center of gravity 615 of the battery cell 120 can correspond to the lateral midpoint 610 of the battery cell 120. For example, the battery cell 120 can include a symmetrical housing 230 such that the center of gravity 615 of the battery cell 120 is located at the longitudinal or lateral center of the housing 230 of the battery cell 120. The center of gravity 615 of the battery cell 120 can be offset from the lateral midpoint 610 of the battery cell 120. For example, the battery cell 120 can include one or more components disposed at a first end of the housing 230 of the battery cell 120 (e.g., one or more terminals or other components) such that the battery cell 120 is not exactly symmetrical in mass. In other words, one or more components of the battery cell 120 can cause the center of gravity 615 to deviate from the lateral midpoint 610 of the battery cell 120. Even in this case, the middle portion 605 of the battery cell 120 can cross the center of gravity 615 of the battery cell 120 such that at least a portion of the pocket 325 surrounds the center of gravity 615 of the battery cell 120 (e.g., the lateral line 620 that extends through the center of gravity 615 is within the middle portion 605 such that the lateral line 620 extends through a surface of the pocket 325).

The carrier 310 can include various features or components that provide structure for the carrier 310. For example, the carrier 310 can include one or more ribs 910 disposed along a portion of the carrier 310, such as an intersection 905 between two or more side walls 315 of the carrier 310. The ribs 910 can protrude from a surface 915 of the intersection 905. For example, the ribs 910 can protrude 1-10 mm from the surface 915 of the intersection 905. The ribs 910 can protrude more or less than 1-10 mm from the surface 915.

The carrier 310 can include various materials. For example, the carrier 310 can be formed from one or more plastic materials. The carrier 310 can be formed by various techniques including, but not limited to, injection molding. The carrier 310 can include a variety of materials that facilitate providing rigidity and structure for the carrier 310. For example, the carrier 310 can include one or more glass-filled materials coupled (e.g., embedded, molded with, or coupled in another way) with the material of the carrier 310. For example, the carrier 310 can include about 15% glass-filled materials. The carrier 310 can include more or less glass-filled materials.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. References to top or bottom, or other orientations, can indicate positioning when the battery pack 110 is in an orientation such as an installed orientation in the electric vehicle 105.

Other substitutions, modifications, changes and omissions can also be made in the design, operating conditions and arrangement of the disclosed elements and operations without departing from the scope of the present disclosure. For example, the thermal component 215 can be coupled with the battery module 115 at various positions of the battery module 115. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. An apparatus, comprising:
a carrier comprising a first end, a second end, and a pocket disposed between the first and second ends;
the pocket configured to receive a battery cell to couple the carrier with the battery cell at a middle portion of the battery cell; and
the pocket surrounds the middle portion of the battery cell such that portions of the battery cell disposed between the pocket and the first end of the carrier and between the pocket and the second end of the carrier are free from the pocket.

2. The apparatus of claim 1, comprising:
an adhesive joint formed between the pocket and the battery cell at the middle portion of the battery cell; and
at least a portion of the adhesive joint surrounds a center of gravity of the battery cell.

3. The apparatus of claim 1, comprising:
the carrier comprises a plastic material; and
the carrier comprises at least one glass-filled fiber coupled with the plastic material.

4. The apparatus of claim 1, comprising:
the carrier comprises a base having a plurality of walls; and
the base includes a plurality of ribs formed with an intersection of a first wall of the plurality of walls and a second wall of the plurality of walls.

5. The apparatus of claim 1, comprising:
the pocket comprises an adhesive to dampen vibration of the battery cell.

6. The apparatus of claim 1, comprising:
the carrier at least partially defines a first submodule of a battery module; and.

7. The apparatus of claim 1, comprising:
the carrier comprises a plurality of pockets arranged in a distributed array pattern; and
each pocket of the plurality of pockets is configured to receive a corresponding battery cell.

8. The apparatus of claim 1, comprising:
the middle portion of the battery cell crosses a lateral midpoint of the battery cell; and
a center of gravity of the battery cell corresponds to the lateral midpoint of the battery cell.

9. The apparatus of claim 1, comprising:
the middle portion of the battery cell crosses a lateral midpoint of the battery cell;
a center of gravity of the battery cell is offset from the lateral midpoint of the battery cell; and
the middle portion of the battery cell crosses the center of gravity of the battery cell.

10. A battery, comprising:
a battery cell;
a carrier comprising a first end, a second end, and a pocket disposed between the first and second ends and configured to receive the battery cell;
the pocket configured to couple the carrier with the battery cell at a middle portion of the battery cell;
the pocket surrounds the middle portion of the battery cell and is disposed such that portions of the battery cell between the pocket and the first end of the carrier and between the pocket and the second end of the carrier are positioned without touching the pocket; and
the middle portion of the battery cell includes a lateral midpoint of the battery cell.

11. The battery of claim 10, comprising:
an adhesive joint formed between the pocket and the battery cell at the middle portion of the battery cell; and
at least a portion of the adhesive joint surrounds a center of gravity of the battery cell.

12. The battery of claim 10, comprising:
the carrier comprises a plastic material; and
the carrier comprises at least one glass-filled fiber coupled with the plastic material.

13. The battery of claim 10, comprising:
the carrier comprises a base having a plurality of walls; and
the base includes a plurality of ribs formed with an intersection of a first wall of the plurality of walls and a second wall of the plurality of walls.

14. The battery of claim 10, comprising:
the pocket comprises an adhesive to dampen vibration of the battery cell.

15. The battery of claim 10, comprising:
the carrier at least partially defines a first submodule; and.

16. The battery of claim 10, comprising:
the carrier comprises a plurality of pockets arranged in a distributed array pattern; and
each pocket of the plurality of pockets is configured to receive a corresponding battery cell.

17. The battery of claim 10, comprising:
a center of gravity of the battery cell corresponds to the lateral midpoint of the battery cell.

18. The battery of claim 10, comprising:
a center of gravity of the battery cell is offset from the lateral midpoint of the battery cell; and
the middle portion of the battery cell crosses the center of gravity of the battery cell.

19. A method, comprising:
providing a carrier comprising a first end, a second end, and a pocket disposed between the first and second ends;
receiving, by the pocket, a battery cell to couple the carrier with the battery cell at a middle portion of the battery cell;
the pocket surrounds the middle portion of the battery cell such that portions of the battery cell disposed between the pocket and the first end of the carrier and between the pocket and the second end of the carrier are free from the pocket; and
the middle portion of the battery cell crosses a lateral midpoint of the battery cell.

20. The method of claim 19, comprising:
forming an adhesive joint between the pocket and the battery cell at the middle portion of the battery cell; and
at least a portion of the adhesive joint surrounds a center of gravity of the battery cell.
